(19) United States
(12) Patent Application Publication
(10) Pub. No.: US 2026/0264519 A1
(43) Pub. Date: Sep. 10, 2026

(54) SYSTEM AND METHOD OF FUEL CONSUMPTION ASSISTANCE FOR A MOTORIZED VEHICLE

(71) Applicant: GM GLOBAL TECHNOLOGY OPERATIONS LLC, Detroit, MI (US)

(72) Inventors: Robert A. Short, Holly, MI (US); Bryan J. Miller, Davisburg, MI (US); Michael P. Kirbitz, Holly, MI (US)

(73) Assignee: GM GLOBAL TECHNOLOGY OPERATIONS LLC, Detroit, MI (US)

(21) Appl. No.: 19/072,027

(22) Filed: Mar. 6, 2025

(51) Int. Cl. B60K 35/28; B60K 35/22; B60Q 1/50

(52) U.S. Cl. CPC B60K 35/28; B60K 35/22; B60Q 1/543; B60G 2800/012; B60G 2800/014; B60K 2360/167; B60K 2360/178

(57) ABSTRACT

A method of fuel consumption assistance includes enabling a suspension fuel range extension (SFRE) when it is determined that a vehicle is being operated during a low fuel driving event. The SFRE includes limiting a vehicle speed to a fuel tank flow angle (FTFA) speed limit, activating vehicle hazard lights, determining a vehicle stance of the vehicle, and adjusting the vehicle stance from a first vehicle stance to a second vehicle stance, such that adjusting the first vehicle stance to the second vehicle stance is configured to direct a flow of fuel within a fuel tank towards a fuel pump of the vehicle. Adjusting the first vehicle stance to the second vehicle stance includes activating at least one of a plurality of active chassis components to change at least one of a roll and/or a pitch of the vehicle.

### INTRODUCTION

The concepts described herein relate generally to a systems and methods of fuel consumption assistance for motorized vehicles. More specifically, aspects of this disclosure relate to extending a fuel range of a vehicle using active chassis components.

As a motorized vehicle, powered at least in part by an internal combustion (IC) engine, consumes fuel from within a fuel tank during operation, there are often design constraints associated with the fuel tank, for example but not limited to, packaging constraints, that lead to small “pockets” of fuel to collect and/or settle within the fuel tank. These “pockets” of fuel are created, for example but not limited to, by indentations formed in the fuel tank that allow for attachment belts to be positioned for securing the fuel tank to, for example but not limited to, a vehicle frame.

A fuel pump arranged within the fuel tank is operable to deliver fuel to the IC engine. Due to the relative position that the fuel tank is installed with respect to the vehicle, i.e., the vehicle stance, when the fuel level in the fuel tank gets low, the fuel that is trapped within the “pockets” becomes unavailable to reach the fuel pump, and the vehicle essentially “runs” out of fuel even though a usable amount of fuel remains within the fuel tank.

### SUMMARY

In view of the above discussion, it is useful to develop a system and method of fuel consumption assistance that utilizes existing active chassis components to adjust a vehicle stance of a vehicle to direct a flow of fuel trapped within pockets formed in a fuel tank towards a fuel pump to be delivered to an internal combustion (IC) engine.

A vehicle having a fuel consumption assistance control system may include a powertrain. The vehicle may include, but is not limited to, a commercial vehicle, an industrial vehicle, a passenger vehicle, an aircraft, a watercraft, a train or the like.

The powertrain may include a power-source configured to generate a power-source torque for propulsion of the vehicle via driven wheels relative to a road surface. The power-source may include an internal combustion (IC) engine.

The powertrain may also include an additional power-source, for example but not limited to, an electric motor-generator or a fuel cell. The power-sources may act in concert to power the vehicle.

The vehicle may include a fuel tank, a rechargeable energy storage system (RESS) (if so equipped), a fuel consumption assistance control system, which may include a controller, a plurality of sensors, a display, for example but not limited to a display arranged within an instrument panel cluster (IPC), and a plurality of active chassis components, for example but not limited to, air suspension springs and/or active stabilizer bars.

The fuel tank may include a fuel pump and a fuel filler. The fuel tank may be arranged within the vehicle. The fuel pump may be arranged within the fuel tank. The fuel pump may be operable to deliver fuel from the fuel tank to the IC engine during operation. The fuel filler may extend from the fuel tank to an external fuel access, which may be disposed within the vehicle.

The RESS (if so equipped) may be configured to store electrical power through heat-producing electro-chemical reactions and discharge DC power for energizing the vehicle during use.

The controller may be in communication with the powertrain, the RESS (if so equipped), the plurality of sensors, which may include, for example but not limited to, a fuel sensor and a speed sensor, and the display. The controller may be programmable and may include a central processing unit (CPU) that regulates various functions of the vehicle, the RESS (if so equipped), the plurality of sensors, and/or the display.

In either of the above configurations, the controller may include a processor and tangible, non-transitory memory, which may include instructions for operation of vehicle, the RESS (if so equipped), the display, and the plurality of sensors programmed therein. The memory may be an appropriate recordable medium that participates in providing computer-readable data or process instructions. Such a recordable medium may take many forms, including, but not limited to, non-volatile media and volatile media.

Non-volatile media for the controller may include, for example, optical or magnetic disks and other persistent memory. Volatile media may include, for example, dynamic random access memory (DRAM), which may constitute a main memory. Such instructions may be transmitted by one or more transmission medium, including coaxial cables, copper wire and fiber optics, including the wires that comprise a system bus coupled to a processor of a computer, or via a wireless connection.

Memory of the controller may also include a flexible disk, hard disk, magnetic tape, another magnetic medium, a CD-ROM, DVD, another optical medium, etc. The controller may be configured or equipped with other required computer hardware, such as a high-speed clock, requisite Analog-to-Digital (A/D) and/or Digital-to-Analog (D/A) circuitry, input/output circuitry and devices (I/O), as well as appropriate signal conditioning and/or buffer circuitry. Algorithms required by the controller or accessible thereby, including, but not limited to predictive algorithms, may be stored in the memory and automatically executed to provide the required functionality of the vehicle including but not limited to a fuel consumption assistance system including a plurality of sensors and a plurality of active chassis components including, for example but not limited to, air suspension springs, and/or active stabilizer bars.

The controller may be disposed in the vehicle and may be in communication with the powertrain including the IC engine and the electric motor-generator (if so equipped), the fuel tank including the fuel pump, the RESS (if so equipped), the display, the fuel consumption assistance system including but not limited to the plurality of sensors and the plurality of active chassis components, and the vehicle.

The fuel tank may include a top side and a bottom side opposite the top side, a front end, and a rear end. Attachment indentations may be formed in the fuel tank at various locations to facilitate attachment of the fuel tank to the vehicle via a plurality of attachment straps.

A fuel filler may extend upward from the top side of the fuel tank to an external fuel access. A fuel pump, which may be operable to provide fuel to the powertrain may be arranged within the fuel tank. At least one baffle may be arranged within the fuel tank to limit “slosh” of fuel within the fuel tank.

According to one aspect of the disclosure, a vehicle stance may include a first vehicle stance. The vehicle in the first vehicle stance may include a vehicle chassis, a plurality of active chassis components, which may be arranged in adjustable communication with the vehicle chassis, and the fuel consumption assistance control system, which may be in communication with a plurality of active chassis components, which may include air suspension springs, which may be operable to adjust a pitch of the vehicle.

A pair of driven wheels may be arranged opposite to one another and adjacent to a front end of the vehicle, and a pair of driven wheels may be arranged opposite to one another and adjacent to a rear end of the vehicle. Air suspension springs may be arranged adjacent to the driven wheels. The air suspension springs may be in adjustable communication with the vehicle chassis.

A fuel tank having a front end and a rear end, may include a fuel pump disposed within the fuel tank. The fuel tank may be arranged within the vehicle chassis, and may be fixedly attached to the vehicle. The fuel pump may be arranged within the fuel tank adjacent to the rear end of the fuel tank.

In the first vehicle stance, the pitch of the vehicle may be zero, i.e., the vehicle chassis including the fuel tank may be parallel to a road surface and a fuel level within the fuel tank may be a first fuel level, which may be equal to or below a fuel intake portion of the fuel pump.

In a second vehicle stance, a vehicle may be adjusted from a first vehicle stance to the second vehicle stance via an adjustment made to a pitch of the vehicle by a fuel assistance control system.

In the second vehicle stance, the vehicle may include a vehicle chassis, a plurality of active chassis components, which may be arranged in adjustable communication with the vehicle chassis, and the fuel consumption assistance control system, which may be in communication with a plurality of active chassis components, which may include air suspension springs, which may be operable to adjust the pitch of the vehicle and/or active stabilizer bars, which may be operable to adjust a roll of the vehicle.

A pair of driven wheels may be arranged opposite one another and adjacent to a front end of the vehicle, and a pair of driven wheels, which may be arranged opposite to one another and adjacent to a rear end of the vehicle. Air suspension springs may be arranged adjacent to each of the driven wheels. The air suspension springs may be in adjustable communication with the vehicle chassis.

A fuel tank having a front end and a rear end, may include a fuel pump disposed within the fuel tank. The fuel tank may be arranged within the vehicle chassis, and may be fixedly attached to the vehicle. The fuel pump may be arranged within the fuel tank adjacent to the rear end of the fuel tank.

In the second vehicle stance, a vehicle stance of the vehicle may be adjusted from a first vehicle stance to an adjusted or second vehicle stance by adjusting the pitch of the vehicle in the first vehicle stance to be greater than or less than the pitch of the vehicle in the second vehicle stance, i.e., the vehicle chassis including the fuel tank may be adjusted by the fuel consumption assistance control system to no longer be parallel to a road surface, and the fuel level within the fuel tank may be a second fuel level, which is equal to or above a fuel intake portion of the fuel pump.

The pitch of the vehicle may be adjusted by the fuel consumption assistance control system in accordance with the fuel consumption assistance method discussed below.

According to another aspect of the present disclosure, a vehicle stance may include a first vehicle stance. The vehicle in the first vehicle stance may include a vehicle chassis, a plurality of active chassis components, which may be arranged in adjustable communication with the vehicle chassis, and the fuel consumption assistance control system, which may be in communication with a plurality of active chassis components, which may include air suspension springs, which may be operable to adjust a pitch of the vehicle and/or active stabilizer bars, which may be operable to adjust a roll of the vehicle.

A pair of driven wheels may be arranged opposite to one another and adjacent to a front end of the vehicle, and a pair of driven wheels may be arranged opposite to one another and adjacent to a rear end of the vehicle. Air suspension springs may be arranged adjacent to the driven wheels. At least one of the active stabilizer bars may extend cross-car between each of the pairs of driven wheels. Both the air suspension springs and/or the active stabilizer bars may be in adjustable communication with the vehicle chassis.

A fuel tank having a front end and a rear end, may include a fuel pump disposed within the fuel tank. The fuel tank may be arranged within the vehicle chassis, and may be fixedly attached to the vehicle. The fuel pump may be arranged within the fuel tank adjacent to the rear end of the fuel tank.

In the first vehicle stance, the roll of the vehicle may be zero, i.e., the vehicle chassis including the fuel tank may be parallel to a road surface and a fuel level within the fuel tank may be a first fuel level, which may be equal to or below a fuel intake portion of the fuel pump.

In a second vehicle stance, a vehicle may be adjusted from a first vehicle stance to the second vehicle stance via an adjustment made to a roll of the vehicle by the fuel assistance control system.

The vehicle may include a vehicle chassis, a plurality of active chassis components, which may be arranged in adjustable communication with the vehicle chassis, and the fuel consumption assistance control system, which may be in communication with a plurality of active chassis components, which may include air suspension springs, which may be operable to adjust a pitch of the vehicle, as discussed above, and active stabilizer bars, which may be operable to adjust the roll of the vehicle.

A pair of driven wheels may be arranged opposite to one another and adjacent to a front end of the vehicle, and a pair of driven wheels may be arranged opposite one another and adjacent to a rear end of the vehicle. Air suspension springs may be arranged adjacent to the driven wheels, as discussed above. At least one of the active stabilizer bars may extend cross-car between each of the pairs of driven wheels. Both the air suspension springs and/or the active stabilizer bars may be in adjustable communication with the vehicle chassis.

A fuel tank having a front end and a rear end, may include a fuel pump disposed within the fuel tank. The fuel tank may be arranged within the vehicle chassis, and may be fixedly attached to the vehicle. The fuel pump may be arranged within the fuel tank adjacent to the rear end of the fuel tank.

In the second vehicle stance, the roll of the vehicle may be greater than the roll of the vehicle in the first vehicle stance, i.e., the vehicle chassis including the fuel tank may have been adjusted by the fuel consumption assistance control system to no longer be parallel to a road surface, and a fuel level within the fuel tank may be a second fuel level, which may be equal to or above a fuel intake portion of the fuel pump.

The roll of the vehicle may be adjusted by the fuel consumption assistance control system in accordance with the fuel consumption assistance control method discussed below.

A method of fuel consumption assistance may include receiving, via a controller, a low fuel warning (LFW) that may be indicative of a low fuel driving event; determining, via the controller, whether a suspension fuel range extension (SFRE) may be complete when the low fuel warning (LFW) is received; determining, via the controller, whether a vehicle may be operating at speed or not operating at speed when the low fuel warning (LFW) is received; determining, via the controller, whether the vehicle may be operating during the low fuel driving event when it is determined that the vehicle is operating at speed; enabling, via the controller, the SFRE and displaying a first instrument panel cluster (IPC) notification on a display when it is determined that the SFRE is not complete, when it is determined that the vehicle is operating at speed, and when it is determined that the vehicle is being operated during the low fuel driving event; and disabling, via the controller, the SFRE and displaying a second IPC notificationon the display when it is determined that the SFRE is not complete and when it is determined that the vehicle is not operating at speed; receiving, via the controller, a SFRE completion signal when the SFRE is complete; and displaying, via the controller, the second IPC notification on the display when the SFRE is complete, wherein the second IPC notification indicates that the SFRE is complete.

The low fuel warning (LFW) received by the controller, may be received from, for example but not limited to, a fuel sensor, which may detect a fuel level within a fuel tank.

The SFRE may include limiting a vehicle speed to a fuel tank flow angle (FTFA) speed limit, when it is determined that the vehicle is being operated during the low fuel driving event; activating vehicle hazard lights, when it is determined that the vehicle is being operated during the low fuel driving event; determining a vehicle stance of the vehicle; and adjusting the vehicle stance from a first vehicle stance to a second vehicle stance, wherein adjusting the first vehicle stance to the second vehicle stance may be configured to direct a flow of fuel within a fuel tank towards a fuel pump of the vehicle.

The vehicle may be determined to not be operating at speed when it is determined that the vehicle is experiencing one of a coasting event, a braking event, and/or a shifted to park event.

The first IPC notification may include at least one of a vehicle stance notification and/or a speed limiting notification, and the second IPC notification may include an SFRE completion status, for example but not limited to that the SFRE is complete and/or that the SFRE is not complete.

The first vehicle stance of the vehicle may be determined based on the vehicle stance notification displayed.

According to one aspect of the disclosure, adjusting the first vehicle stance of the vehicle to the second vehicle stance may include activating at least one of a plurality of active chassis components to change at least one of a roll and/or a pitch of the vehicle.

According to one aspect of the disclosure, the method may further include adjusting the second vehicle stance back to the first vehicle stance after the fuel has been redirected towards the fuel pump of the vehicle.

According to another aspect of the disclosure, the method may further include removing the FTFA speed limit after the vehicle has been adjusted from the second vehicle stance back to the first vehicle stance.

According to one aspect of the disclosure, determining whether the vehicle is being operated during the low fuel driving event may include receiving a first diagnostic code notification from the controller.

The first diagnostic code notification received by the controller may be generated based on a signal received from, for example but not limited to, one of a plurality of sensors.

According to one aspect of the disclosure, the FTFA speed limit may be a predetermined vehicle speed.

According to another aspect of the disclosure, the FTFA speed limit may be calibratable.

According to one aspect of the disclosure, the second IPC notification may indicate that the SFRE is complete.

According to another aspect of the disclosure, the method may further include an SFRE exit strategy that may include detecting, via the controller, a SFRE exit criteria, and disabling, via the controller, the SFRE when the SFRE exit criteria includes at least one of a driver exit and/or a door ajar.

Disabling the SFRE may include stopping adjustment of the vehicle stance from the first vehicle stance to the second vehicle stance; and displaying the second IPC notification on the display, wherein the second IPC may indicate that the SFRE did not complete.

The SFRE exit strategy may further include enabling, via the controller, the SFRE when a driver re-entry is detected.

According to another aspect of the disclosure, the method may further include determining, via the controller, a fuel level within the fuel tank, disabling, via the controller, the SFRE when it is determined that the fuel tank is empty, and displaying, via the controller, the second IPC notification on the display when the vehicle has been refueled, wherein the second IPC notification may indicate that the SFRE is complete.

The fuel tank may be empty when the fuel level is below a predetermined fuel level, which may be sensed by a fuel sensor.

By incorporating a fuel consumption assistance control system that utilizes existing active chassis components to adjust a vehicle stance of a vehicle, fuel trapped within pockets formed in a fuel tank may be directed towards a fuel pump for delivery to an internal combustion (IC) engine increasing the amount of usable fuel available, thereby extending a driving range of the vehicle during extremely low fuel driving events.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure which, taken together with the description, serve to explain the principles of the disclosure.

FIG. 1 is a schematic illustration of a vehicle having both an internal combustion engine and an optional electrical propulsion system in accordance with the present disclosure.

FIG. 2 is a schematic illustration of an isometric side view of a fuel tank in accordance with the present disclosure.

FIG. 3 is a schematic illustration of a vehicle including a fuel consumption assistance control system in accordance with the present disclosure, the vehicle in a first vehicle stance.

FIG. 3A is a schematic illustration of a vehicle including a fuel consumption assistance control system in accordance with the present disclosure, the vehicle adjusted to a second vehicle stance via changing a pitch of the vehicle.

FIG. 4 is a schematic illustration of a vehicle including a fuel consumption assistance control system in accordance with the present disclosure, the vehicle in a first vehicle stance.

FIG. 4A is a schematic illustration of a vehicle including a fuel consumption assistance control system in accordance with the present disclosure, the vehicle adjusted to a second vehicle stance via changing a roll of the vehicle.

FIG. 5 is a schematic illustration of a flow chart illustrating a method of fuel consumption assistance in accordance with the present disclosure.

FIG. 6 is a schematic illustration of a flow chart illustrating an exit strategy for a method of fuel consumption assistance in accordance with the present disclosure.

FIG. 7 is a schematic illustration of a flow chart illustrating a disabling of a method of fuel consumption assistance based on a vehicle refueling event in accordance with the present disclosure.

The appended drawings are not necessarily to scale, and may present a somewhat simplified representation of various preferred features of the present disclosure as disclosed herein, including, for example, specific dimensions, orientations, locations, and shapes. Details adjacent to such features will be determined in part by the particular intended application and use environment.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including,” “containing,” “comprising,” “having,” and the like shall mean “including without limitation.” Moreover, words of approximation such as “about,” “almost,” “substantially,” “generally,” “approximately,” etc., may be used herein in the sense of “at, near, or nearly at,” or “within 0-5% of,” or “within acceptable manufacturing tolerances,” or logical combinations thereof.

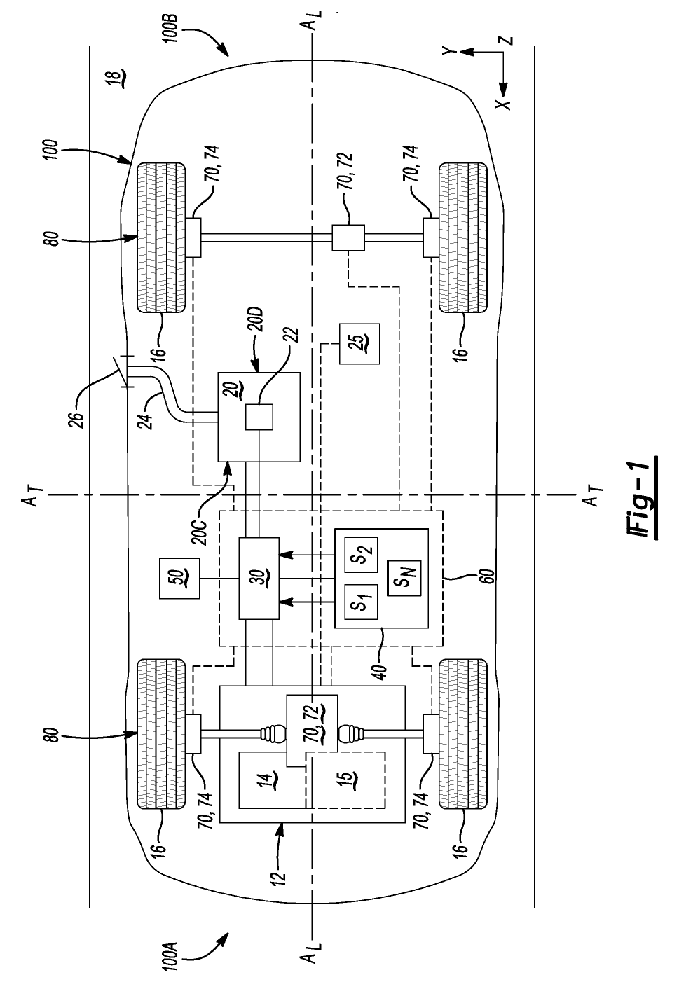

As illustrated in FIG. 1, a vehicle 100 includes a powertrain 12. The vehicle 100 may include, but is not limited to, a commercial vehicle, an industrial vehicle, a passenger vehicle, an aircraft, a watercraft, a train or the like.

The powertrain 12 includes a power-source 14 configured to generate a power-source torque T (not shown) for propulsion of the vehicle 100 via driven wheels 16 relative to a road surface 18. The power-source 14 is depicted as an internal combustion (IC) engine.

As further illustrated in FIG. 1, the powertrain 12 may also include an additional power-source 15, for example but not limited to, an electric motor-generator or a fuel cell. The power-sources 14 and 15 may act in concert to power the vehicle 100.

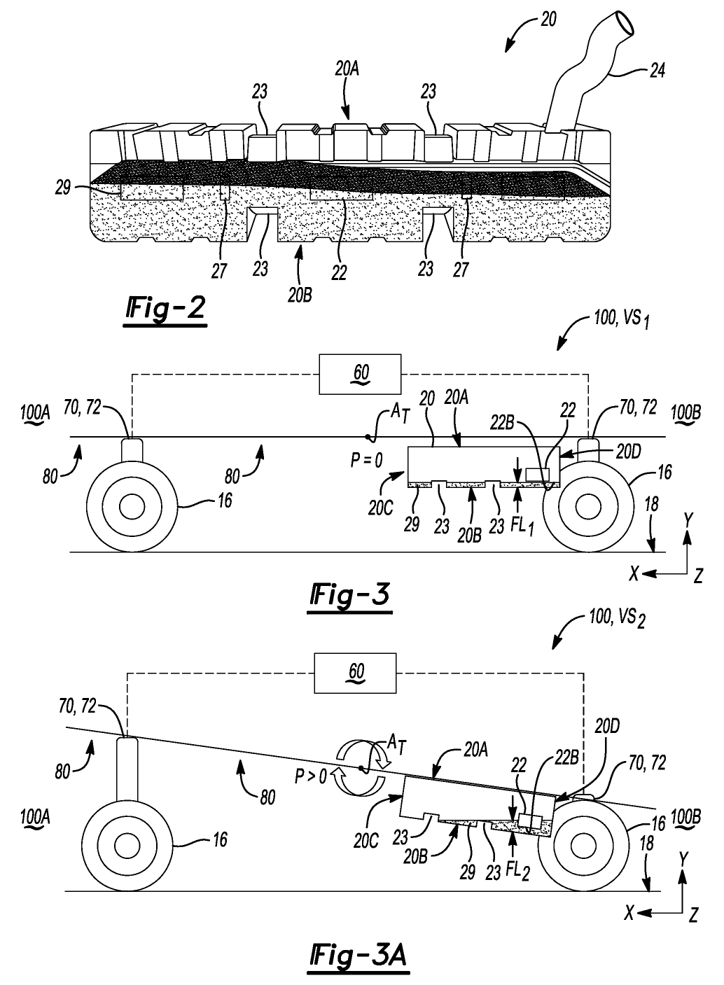

The vehicle 100 includes a fuel tank 20 having a top side 20A (FIG. 2), a bottom side 20B (FIG. 2), a front end 20C and a rear end 20D, a rechargeable energy storage system (RESS) 25 (if so equipped), a fuel consumption assistance control system 60 including a controller 30 and a plurality of sensors 40, a display 50, for example but not limited to a display arranged within an instrument panel cluster (IPC), and a plurality of active chassis components 70, for example but not limited to, air suspension springs 72 and/or active stabilizer bars 74.

The fuel tank 20 includes a fuel pump 22 and a fuel filler 24 (FIG. 2). The fuel tank 20 is arranged within the vehicle 100. The fuel pump 22 arranged within the fuel tank 20 is operable to deliver fuel from the fuel tank 20 to the IC engine 14 during operation. The fuel filler 24 extends from the fuel tank 20 to an external fuel access 26 disposed within the vehicle 100.

The RESS 25 (if so equipped) is configured to store electrical power through heat-producing electro-chemical reactions and discharge DC power for energizing the vehicle 100 during use.

The controller 30 is in communication with the powertrain 12, the RESS 25 (if so equipped), the plurality of sensors 40, S₁ … S_{N} including, for example but not limited to, a fuel sensor S₁ and a speed sensor S₂, and the display 50. The controller 30 is programmable and may include a central processing unit (CPU) that regulates various functions of the vehicle 100, the RESS 25 (if so equipped), the plurality of sensors 40, and/or the display 50.

In either of the above configurations, the controller 30 includes a processor and tangible, non-transitory memory, which includes instructions for operation of vehicle 100, the RESS 25 (if so equipped), the display 50, and the plurality of sensors 40 programmed therein. The memory may be an appropriate recordable medium that participates in providing computer-readable data or process instructions. Such a recordable medium may take many forms, including, but not limited to, non-volatile media and volatile media.

Non-volatile media for the controller 30 may include, for example, optical or magnetic disks and other persistent memory. Volatile media may include, for example, dynamic random access memory (DRAM), which may constitute a main memory. Such instructions may be transmitted by one or more transmission medium, including coaxial cables, copper wire and fiber optics, including the wires that comprise a system bus coupled to a processor of a computer, or via a wireless connection.

Memory of the controller 30 may also include a flexible disk, hard disk, magnetic tape, another magnetic medium, a CD-ROM, DVD, another optical medium, etc. The controller 30 may be configured or equipped with other required computer hardware, such as a high-speed clock, requisite Analog-to-Digital (A/D) and/or Digital-to-Analog (D/A) circuitry, input/output circuitry and devices (I/O), as well as appropriate signal conditioning and/or buffer circuitry. Algorithms required by the controller 30 or accessible thereby, including, but not limited to predictive algorithms, may be stored in the memory and automatically executed to provide the required functionality of the vehicle 100 including but not limited to a fuel consumption assistance system 60 including a plurality of sensors 40 and a plurality of active chassis components 70 including, for example but not limited to, air suspension springs 72, and/or active stabilizer bars 74.

The controller 30 is disposed in the vehicle 100 and is in communication with the powertrain 12 including the IC engine 14 and the electric motor-generator 15 (if so equipped), the fuel tank 20 including the fuel pump 22, the RESS 25 (if so equipped), the display 50, the fuel consumption assistance system 60 including but not limited to the plurality of sensors 40 and the plurality of active chassis components 70, and the vehicle 100.

Referring to FIG. 2 with continued reference to FIG. 1, a side view of a fuel tank 20 is schematically illustrated. The fuel tank 20 includes a top side 20A and a bottom side 20B opposite the top side 20A. Attachment indentations 23 may be formed in the fuel tank 20 at various locations to facilitate attachment of the fuel tank 20 to the vehicle 100 via a plurality of attachment straps (not shown).

A fuel filler 24 extends upward from the top side 20A of the fuel tank 20 to an external fuel access 26 (FIG. 1). A fuel pump 22, which is operable to provide fuel 25 to the powertrain 12 (FIG. 1) is arranged within the fuel tank 20. At least one baffle 27 may be arranged within the fuel tank 20 to limit “slosh” of fuel 29 within the fuel tank 20.

It should be appreciated that, while the fuel pump 22 is shown at a central location within the fuel tank 20, the fuel pump 22 can be located at locations within the fuel tank 20 other than the central location as required by each individual application.

Referring now to FIG. 3, a side view of a vehicle 100 including a fuel consumption assistance control system 60 is schematically illustrated. The vehicle 100 is shown in a first vehicle stance VS₁.

The vehicle 100 includes a vehicle chassis 80, a plurality of active chassis components 70 arranged in adjustable communication with the vehicle chassis 80, and the fuel consumption assistance control system 60 in communication with a plurality of active chassis components 70 including air suspension springs 72, which are operable to adjust a pitch P of the vehicle 100. The pitch P of the vehicle 100 is rotation of the vehicle 100 about a transverse axis A_{T}.

A pair of driven wheels 16 are arranged opposite to one another and adjacent to a front end 100A of the vehicle 100, and a pair of driven wheels 16 are arranged opposite to one another and adjacent to a rear end 100B of the vehicle 100. Air suspension springs 72 are arranged adjacent to the driven wheels 16. The air suspension springs 72 are in adjustable communication with the vehicle chassis 80.

A fuel tank 20, including a fuel pump 22 within the fuel tank 20, is arranged within the vehicle chassis 80, and fixedly attached to the vehicle 100. The fuel pump 22 is arranged within the fuel tank 20 adjacent to a rear end 20D (FIG. 1) of the fuel tank 20.

In the first vehicle stance VS₁, the pitch P of the vehicle 100 is zero, i.e., the vehicle chassis 80 including the fuel tank 20 is parallel to a road surface 18 and a fuel level FL within the fuel tank 20 is a first fuel level FL₁, which is equal to or below a fuel intake portion 22B of the fuel pump 22.

Referring now to FIG. 3A, a side view of a vehicle 100 including a fuel consumption assistance control system 60 is schematically illustrated. The vehicle 100 is shown in a second vehicle stance VS₂, in which the vehicle 100 is adjusted from the first vehicle stance VS₁ (FIG. 3) to the second vehicle stance VS₂ via an adjustment made to a pitch P of the vehicle 100 by the fuel assistance control system 60. The pitch P of the vehicle 100 being a rotation of the vehicle 100 about a transverse axis A_{T}.

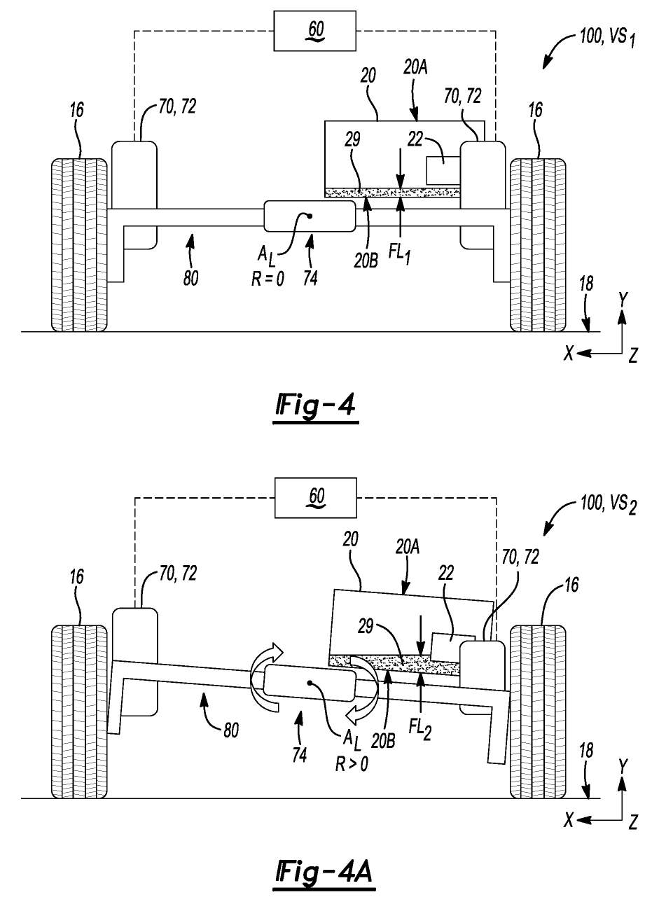

The vehicle 100 includes a vehicle chassis 80, a plurality of active chassis components 70 arranged in adjustable communication with the vehicle chassis 80, and the fuel consumption assistance control system 60 in communication with a plurality of active chassis components 70 including air suspension springs 72, which are operable to adjust the pitch P of the vehicle 100 and/or active stabilizer bars 74 (FIG. 4 and FIG. 4A), which are operable to adjust a roll R of the vehicle 100.

A pair of driven wheels 16 are arranged opposite one another and adjacent to a front end 100A of the vehicle 100, and a pair of driven wheels 16 are arranged opposite to one another and adjacent to a rear end 100B of the vehicle 100. Air suspension springs 72 are arranged adjacent to each of the driven wheels 16. The air suspension springs are in adjustable communication with the vehicle chassis 80.

A fuel tank 20, including a fuel pump 22 disposed within the fuel tank 20, is arranged within the vehicle chassis 80, and fixedly attached to the vehicle 100. The fuel pump 22 is arranged within the fuel tank 20 adjacent to a rear end 20D (FIG. 1) of the fuel tank 20.

In the second vehicle stance VS₂, a stance of the vehicle 100 is adjusted from a first vehicle stance VS₁ (FIG. 3) to an adjusted or second vehicle stance VS₂ (FIG. 3A) by adjusting the pitch P of the vehicle 100 in the first vehicle stance VS₁ to be greater than or less than the pitch P of the vehicle 100 in the second vehicle stance VS₂, i.e., the vehicle chassis 80 including the fuel tank 20 is adjusted by the fuel consumption assistance control system 60 to no longer be parallel to a road surface 18, and the fuel level FL within the fuel tank 20 is a second fuel level FL₂, which is equal to or above a fuel intake portion 22A of the fuel pump 22.

The pitch P of the vehicle 100 is adjusted by the fuel consumption assistance control system 60 as discussed below.

Referring now to FIG. 4, a front view of a vehicle 100 including a fuel consumption assistance control system 60 is schematically illustrated. The vehicle 100 is shown in a first vehicle stance VS₁.

The vehicle 100 includes a vehicle chassis 80, a plurality of active chassis components 70 arranged in adjustable communication with the vehicle chassis 80, and the fuel consumption assistance control system 60 in communication with a plurality of active chassis components 70 including air suspension springs 72, which are operable to adjust a pitch P of the vehicle 100 and/or active stabilizer bars 74, which are operable to adjust a roll R of the vehicle 100. The roll R of a vehicle 100 is a rotation of the vehicle 100 about a longitudinal axis A_{L}.

A pair of driven wheels 16 are arranged opposite to one another and adjacent to a front end 100A of the vehicle 100, and a pair of driven wheels 16 are arranged opposite to one another and adjacent to a rear end 100B of the vehicle 100. Air suspension springs 72 are arranged adjacent to the driven wheels 16. At least one of the active stabilizer bars 74 extends cross-car between each of the pairs of driven wheels 16. Both the air suspension springs 72 and/or the active stabilizer bars 74 are in adjustable communication with the vehicle chassis 80.

A fuel tank 20, including a fuel pump 22 within the fuel tank 20, is arranged within the vehicle chassis 80, and fixedly attached to the vehicle 100. The fuel pump 22 is arranged within the fuel tank 20 adjacent to a rear end 20D (FIG. 1) of the fuel tank 20.

In the first vehicle stance VS₁, the roll R of the vehicle 100 is zero, i.e., the vehicle chassis 80 including the fuel tank 20 is parallel to a road surface 18 and a fuel level FL within the fuel tank 20 is a first fuel level FL₁, which is equal to or below a fuel intake portion 22A of the fuel pump 22.

Referring now to FIG. 4A, a front view of a vehicle 100 including a fuel consumption assistance control system 60 is schematically illustrated. The vehicle 100 is shown in a second vehicle stance VS₂, in which the vehicle 100 is adjusted from the first vehicle stance VS₁ (FIG. 4) to the second vehicle stance VS₂ (FIG. 4A) via an adjustment made to a roll R of the vehicle 100 by the fuel assistance control system 60. The roll R of the vehicle 100 being a rotation of the vehicle 100 about a longitudinal axis A_{L}.

The vehicle 100 includes a vehicle chassis 80, a plurality of active chassis components 70 arranged in adjustable communication with the vehicle chassis 80, and the fuel consumption assistance control system 60 in communication with a plurality of active chassis components 70 including air suspension springs 72, which are operable to adjust a pitch P of the vehicle 100, as discussed above, and active stabilizer bars 74, which are operable to adjust the roll R of the vehicle 100. The roll R of the vehicle 100 is rotation of the vehicle 100 about a longitudinal axis A_{L}.

A pair of driven wheels 16 are arranged opposite to one another and adjacent to a front end 100A of the vehicle 100, and a pair of driven wheels 16 are arranged opposite one another and adjacent to a rear end 100B of the vehicle 100. Air suspension springs 72 are arranged adjacent to the driven wheels 16, as discussed above. At least one of the active stabilizer bars 74 extends cross-car between each of the pairs of driven wheels 16. Both the air suspension springs 72 and/or the active stabilizer bars 74 are in adjustable communication with the vehicle chassis 80.

A fuel tank 20, including a fuel pump 22 within the fuel tank 20, is arranged within the vehicle chassis 80, and fixedly attached to the vehicle 100. The fuel pump 22 is arranged within the fuel tank 20 adjacent to a rear end 20D (FIG. 1) of the fuel tank 20.

In the second vehicle stance VS₂, the roll R of the vehicle 100 is greater than or less than the roll R of the vehicle 100 in the first vehicle stance VS₁, i.e., the vehicle chassis 80 including the fuel tank 20 has been adjusted by the fuel consumption assistance control system to no longer be parallel to a road surface 18, and a fuel level FL within the fuel tank 20 is a second fuel level FL₂, which is equal to or above a fuel intake portion 22A of the fuel pump 22.

The roll R of the vehicle 100 is adjusted by the fuel consumption assistance control system 60 as discussed below.

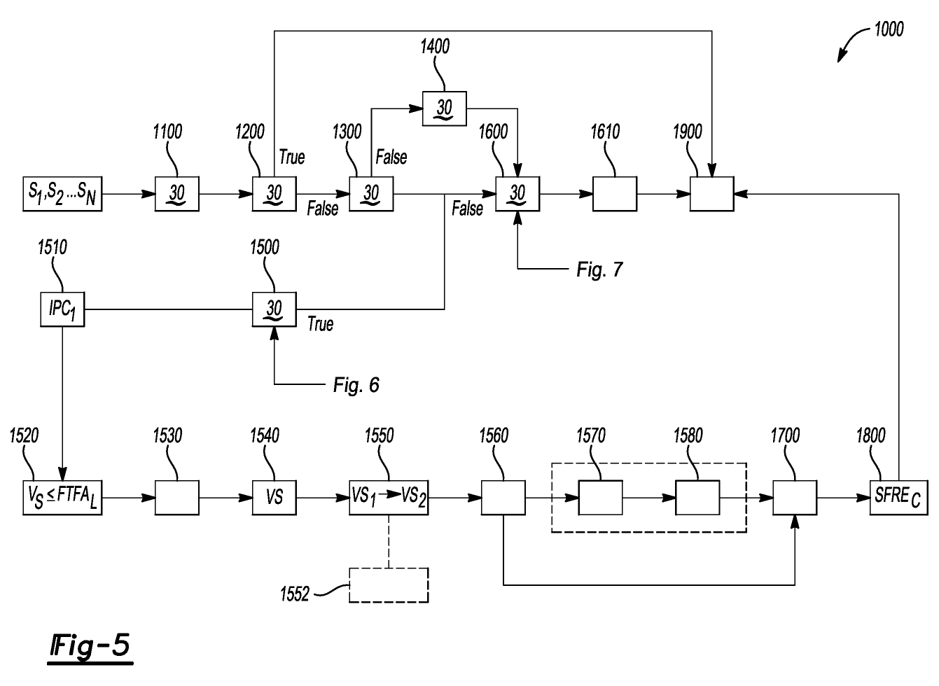

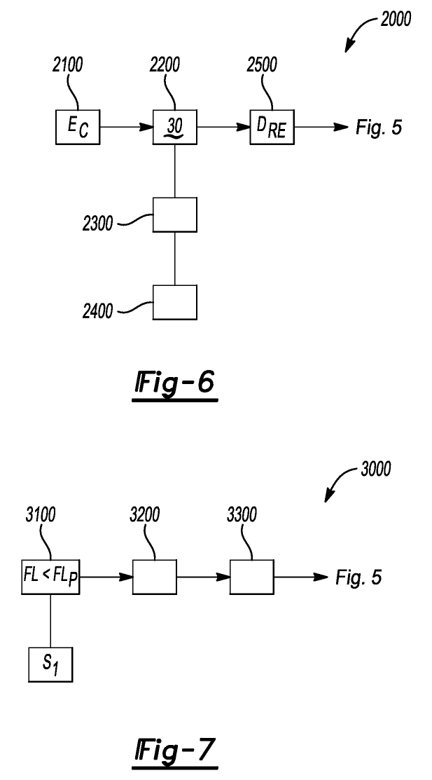

As illustrated in FIG. 5, a method 1000 of fuel consumption assistance includes receiving 1100, via a controller 30, a low fuel warning LFW that is indicative of a low fuel driving event LFDE; determining 1200, via the controller 30, whether a suspension fuel range extension (SFRE) is complete when the low fuel warning LFW is received 1100; determining 1300, via the controller 30, whether a vehicle 100 is operating at speed or not operating at speed when the low fuel warning LFW is received 1100; determining 1400, via the controller 30, whether the vehicle 100 is operating during the low fuel driving event LFDE when it is determined 1300 that the vehicle 100 is operating at speed; enabling 1500, via the controller 30, the SFRE and displaying 1510 a first instrument panel cluster (IPC) notification IPC₁ on a display 50 when it is determined 1200 that the SFRE is not complete, when it is determined 1300 that the vehicle 100 is operating at speed, and when it is determined 1400 that the vehicle 100 is being operated during the low fuel driving event LFDE; and disabling 1600, via the controller 30, the SFRE and displaying 1610 a second IPC notification IPC₂ on the display 50 when it is determined 1200 that the SFRE is not complete and when it is determined 1300 that the vehicle 100 is not operating at speed; receiving 1700, via the controller 30, a SFRE completion signal SFRE_{C} when the SFRE is complete 1900; and displaying 1800, via the controller 30, the second IPC notification IPC₂ on the display 50 when the SFRE is complete, wherein the second IPC notification IPC₂ indicates that the SFRE is complete at 1900.

The low fuel warning LFW received by the controller 30, may be received from, for example but not limited to, a fuel sensor S₁, which detects a fuel level FL within a fuel tank 20.

Determining whether the vehicle 100 is operating at speed may include the controller 30 detecting a vehicle speed V_{S} sensed by, for example but not limited to, a speed sensor S₂.

The SFRE includes limiting 1520 a vehicle speed V_{S} to a fuel tank flow angle (FTFA) speed limit FTFA_{L}, when it is determined 1400 that the vehicle 100 is being operated during the low fuel driving event LFDE; activating 1530 vehicle hazard lights (not shown), when it is determined 1400 that the vehicle 100 is being operated during the low fuel driving event LFDE; determining 1540 a vehicle stance VS of the vehicle 100; and adjusting 1550 the vehicle stance VS from a first vehicle stance VS₁ to a second vehicle stance VS₂, wherein adjusting 1550 the first vehicle stance VS₁ to the second vehicle stance VS₂ is configured to direct 1560 a flow of fuel 29 within a fuel tank 20 towards a fuel pump 22 of the vehicle 100.

It should be appreciated that when the flow of fuel 29 is directed 1560 towards the fuel pump 22 of the vehicle 100, the vehicle 100 may require a restart.

The vehicle 100 is determined to be not operating at speed when it is determined that the vehicle 100 is experiencing one of a coasting event, a braking event, and/or a shifted to park event.

The first IPC notification IPC₁ includes at least one of a vehicle stance notification and/or a speed limiting notification, and the second IPC notification IPC₂ includes an SFRE completion status, for example but not limited to that the SFRE is complete and/or that the SFRE is not complete.

The first vehicle stance VS₁ of the vehicle 100 is determined based on the vehicle stance notification displayed 1510.

According to one aspect of the disclosure, adjusting 1550 the first vehicle stance VS₁ of the vehicle 100 to the second vehicle stance VS₂ includes activating 1552 at least one of a plurality of active chassis components 70 to change at least one of a roll and/or a pitch of the vehicle 100.

According to one aspect of the disclosure, the method 1000 may further include adjusting 1570 the second vehicle stance VS₂ back to the first vehicle stance VS₁ after the fuel 29 has been redirected towards the fuel pump 22 of the vehicle 100.

According to another aspect of the disclosure, the method 1000 may further include removing 1580 the FTFA speed limit FTFA_{L} after the vehicle 100 has been adjusted 1570 from the second vehicle stance VS₂ back to the first vehicle stance VS₁.

According to one aspect of the disclosure, determining 1400 whether the vehicle 100 is being operated during the low fuel driving event LFDE includes receiving 1100 a first diagnostic code (DTC) notification DTC₁ from the controller 30.

The first diagnostic code notification DTC₁ received by the controller 30 may be generated based on a signal received from, for example but not limited to, one of a plurality of sensors 40.

According to one aspect of the disclosure, the FTFA speed limit FTFA_{L} is a predetermined vehicle speed.

According to another aspect of the disclosure, the FTFA speed limit FTFA_{L} is calibratable.

According to one aspect of the disclosure, the second IPC notification IPC₂ indicates that the SFRE is complete.

According to another aspect of the disclosure, as illustrated in FIG. 6, the method 1000 further includes an SFRE exit strategy 2000 that includes detecting 2100, via the controller 30, a SFRE exit criteria E_{C}, and disabling 2200, via the controller 30, the SFRE when the SFRE exit criteria E_{C} includes at least one of a driver exit and/or a door ajar.

Disabling 2200 the SFRE includes stopping 2300 adjustment of the vehicle stance VS from the first vehicle stance VS₁ to the second vehicle stance VS₂; and displaying 2400 the second IPC notification IPC₂ on the display 50, wherein the second IPC IPC₂ indicates that the SFRE did not complete.

The SFRE exit strategy 2000 further including enabling, 2500 via the controller 30, the SFRE when a driver re-entry D_{RE} is detected 2100.

According to another aspect of the disclosure, as illustrated FIG. 7, the method 1000 further includes a SFRE complete strategy 3000 that includes determining 3100, via the controller 30, a fuel level FL within the fuel tank 20, disabling 3200, via the controller 30, the SFRE when it is determined that the fuel tank 20 is empty, and displaying 3300, via the controller 30, the second IPC notification IPC₂ on the display 50 when the vehicle 100 has been refueled, wherein the second IPC notification IPC₂ indicates that the SFRE is complete.

The fuel tank 20 is empty when the fuel level FL is below a predetermined fuel level FL_{P}, which may be sensed by a fuel sensor S₁.

By incorporating a fuel consumption assistance control system that utilizes existing active chassis components to adjust a vehicle stance of a vehicle, fuel trapped within pockets formed in a fuel tank can be directed towards a fuel pump for delivery to an internal combustion (IC) engine increasing the amount of usable fuel available, thereby extending a driving range of the vehicle during extremely low fuel driving events.

These and other attendant benefits of the present disclosure will be appreciated by those skilled in the art in view of the foregoing disclosure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A method of fuel consumption assistance comprising:
receiving, via a controller, a low fuel warning that is indicative of a low fuel driving event of a vehicle;
determining, via the controller, whether a suspension fuel range extension (SFRE) is complete when the low fuel warning is received;
determining, via the controller, whether the vehicle is operating at speed or not operating at speed when the low fuel warning is received;
determining, via the controller, whether the vehicle is operating during a low fuel driving event when it is determined that the vehicle is operating at speed;
enabling, via the controller, the SFRE and displaying a first instrument panel cluster (IPC) notification on a display when it is determined that the SFRE is not complete, when it is determined that the vehicle is operating at speed, and when it is determined that the vehicle is being operated during the low fuel driving event; and
disabling, via the controller, the SFRE and displaying a second IPC notification on the display when it is determined that the SFRE is not complete and when it is determined that the vehicle is not operating at speed, wherein the SFRE includes:
limiting a vehicle speed to a fuel tank flow angle (FTFA) speed limit, when it is determined that the vehicle is being operated during the low fuel driving event;
activating vehicle hazard lights, when it is determined that the vehicle is being operated during the low fuel driving event;
determining a vehicle stance of the vehicle; and
adjusting the vehicle stance from a first vehicle stance to a second vehicle stance, wherein adjusting the first vehicle stance to the second vehicle stance is configured to direct a flow of fuel within a fuel tank towards a fuel pump of the vehicle; and
receiving, via the controller, a SFRE completion signal when the SFRE is complete; and
displaying, via the controller, the second IPC notification on the display when the SFRE is complete, wherein the second IPC notification indicates that the SFRE is complete.

2. The method of fuel consumption assistance as recited in claim 1, wherein the vehicle is determined to be not operating at vehicle speed when it is determined that the vehicle is experiencing one of a coasting event, a braking event, and/or a shifted to park event.

3. The method of fuel consumption assistance as recited in claim 1, wherein the first IPC notification includes at least one of a vehicle stance notification and/or a speed limiting notification.

4. The method of fuel consumption assistance as recited in claim 3, wherein the first vehicle stance of the vehicle is determined based on the vehicle stance notification displayed.

5. The method of fuel consumption assistance as recited in claim 1, wherein adjusting the first vehicle stance of the vehicle to the second vehicle stance includes activating at least one of a plurality of active chassis components to change at least one of a roll and/or a pitch of the vehicle.

6. The method of fuel consumption assistance as recited in claim 5, including adjusting the second vehicle stance back to the first vehicle stance after the fuel has been redirected towards the fuel pump of the vehicle.

7. The method of fuel consumption assistance as recited in claim 6, including removing the FTFA speed limit after the vehicle has been adjusted from the second vehicle stance back to the first vehicle stance.

8. The method of fuel consumption assistance as recited in claim 1, wherein determining whether the vehicle is being operated during the low fuel driving event includes receiving a first diagnostic code (DTC) notification from the controller.

9. The method of fuel consumption assistance as recited in claim 1, wherein the FTFA speed limit is a predetermined vehicle speed.

10. The method of fuel consumption assistance as recited in claim 1, wherein the FTFA speed is calibratable.

11. The method of fuel consumption assistance as recited in claim 1, wherein the second IPC notification indicates that the SFRE is complete.

12. The method of fuel consumption assistance as recited in claim 1, further including an SFRE exit strategy, wherein the SFRE exit strategy includes:
detecting, via the controller, an SFRE exit criteria;
disabling, via the controller, the SFRE when the SFRE exit criteria includes at least one of a driver exit and/or a door ajar is detected, wherein disabling the SFRE includes:
stopping adjustment of the vehicle stance from the first vehicle stance to the second vehicle stance; and
displaying the second IPC notification on the display, wherein the second IPC notification indicates that the SFRE did not complete.

13. The method of fuel consumption assistance as recited in claim 12, wherein the SFRE exit strategy further includes re-enabling, via the controller, the SFRE when a driver re-entry is detected.

14. The method of fuel consumption assistance as recited in claim 1, further including:
determining, via the controller, a fuel level within the fuel tank; and
disabling, via the controller, the SFRE when it is determined that the fuel tank is empty.

15. The method of fuel consumption assistance as recited in claim 14, including displaying, via the controller, the second IPC notification on the display when the vehicle has been refueled, wherein the second IPC notification indicates that the SFRE is complete.

16. A fuel consumption assistance control system for a vehicle, the fuel consumption assistance control system comprising:
a controller in communication with an internal combustion (IC) engine, a plurality of sensors, and a fuel tank, wherein the controller is configured to:
receive a low fuel warning from the vehicle;
determine whether a suspension fuel range extension (SFRE) is complete, when the low fuel warning is received;
determine whether the vehicle is operating at speed or not operating at speed;
determine whether the vehicle is operating during a low fuel driving event when it is determined that the vehicle is operating at speed;
enable the SFRE and display a first instrument panel cluster (IPC) notification on a display when it is determined that the SFRE is not complete, when it is determined that the vehicle is operating at speed, and when it is determined that the vehicle is being operated during the low fuel driving event; and
enable the SFRE and display the first IPC notification on the display when it is determined that the SFRE is not complete and when it is determined that the vehicle is not operating at speed, wherein the SFRE includes:
limiting a vehicle speed to a fuel tank flow angle (FTFA) speed limit, when it is determined that the vehicle is being operated during the low fuel driving event;
limiting the vehicle speed to the FTFA speed limit, when it is determined that the vehicle is being operated during the low fuel driving event;
activating vehicle hazard lights, when it is determined that the vehicle is being operated during the low fuel driving event;
determining a vehicle stance of the vehicle; and
adjusting the vehicle stance from a first vehicle stance to a second vehicle stance, wherein adjusting the first vehicle stance to the second vehicle stance is configured to direct a flow of fuel within a fuel tank towards a fuel pump of the vehicle; and
receive a SFRE completion signal when the SFRE is complete; and
display a second IPC notification on the display when the SFRE is complete, wherein the second IPC notification indicates that the SFRE is complete.

17. The fuel consumption assistance control system as recited in claim 16, wherein adjusting the first vehicle stance of the vehicle to the second vehicle stance includes activating at least one of a plurality of active chassis components to change at least one of a roll and/or a pitch of the vehicle.

18. The fuel consumption assistance control system as recited in claim 17, including adjusting the second vehicle stance back to the first vehicle stance after the fuel has been redirected towards the fuel pump of the vehicle.

19. The fuel consumption assistance control system as recited in claim 18, including removing the FTFA speed limit after the vehicle has been adjusted from the second vehicle stance back to the first vehicle stance.

20. A vehicle having fuel consumption assistance, the vehicle comprising:
a vehicle chassis;
a plurality of active chassis components arranged in adjustable communication with the vehicle chassis, wherein at least one of the active chassis components is operable to adjust at least one of a pitch and/or a roll of the vehicle;
an internal combustion (IC) engine arranged within the vehicle chassis, wherein the IC engine is configured to generate a power-source torque for propulsion of the vehicle;
a fuel tank having a fuel pump arranged within the fuel tank, wherein the fuel tank is arranged within the vehicle chassis, and configured to provide fuel to the IC engine;
a plurality of sensors arranged within the vehicle, wherein the plurality of sensors includes a fuel sensor in communication with the fuel tank;
an instrument panel cluster (IPC) including a display, the IPC arranged within the vehicle;
a fuel consumption assistance control system including:
a controller in communication with the plurality of active chassis components, the internal combustion (IC) engine, the plurality of sensors, the fuel tank, and the display, wherein the controller is configured to:
receive a low fuel warning from the fuel sensor;
determine whether a suspension fuel range extension (SFRE) is complete, when the low fuel warning is received from the fuel sensor;
determine whether the vehicle is operating at speed or not operating at speed;
determine whether the vehicle is operating during a low fuel driving event when it is determined that the vehicle is operating at speed;
enable the SFRE and display a first IPC notification on the display when it is determined that the SFRE is not complete, when it is determined that the vehicle is operating at speed, and when it is determined that the vehicle is being operated during the low fuel driving event; and
enable the SFRE and display the first IPC notification on the display when it is determined that the SFRE is not complete and when it is determined that the vehicle is not operating at speed, wherein the SFRE includes:
limiting a vehicle speed to a fuel tank flow angle (FTFA) speed limit, when it is determined that the vehicle is being operated during the low fuel driving event;
limiting the vehicle speed to the FTFA speed limit, when it is determined that the vehicle is being operated during the low fuel driving event;
activating vehicle hazard lights, when it is determined that the vehicle is being operated during the low fuel driving event;
determining a vehicle stance of the vehicle; and
adjusting the vehicle stance from a first vehicle stance to a second vehicle stance, wherein adjusting the first vehicle stance to the second vehicle stance is configured to direct a flow of fuel within the fuel tank towards the fuel pump of the vehicle; and
receive a SFRE completion signal when the SFRE is complete; and
display a second IPC notification on the display when the SFRE is complete, wherein the second IPC notification indicates that the SFRE is complete.
